(19) United States
(12) Patent Application Publication
(10) Pub. No.: US 2012/0276362 A1
(43) Pub. Date: Nov. 1, 2012

(54) FAY SURFACE SEALANT APPLICATION

(75) Inventors: Paul H. Denavit, Woodbridge, CT (US); William E. Hovan, III, Oxford, CT (US); Christian A. Rogg, New Milford, CT (US); Jonathan Bremmer, Glastonbury, CT (US); Jeffrey G. Sauer, Woodbury, CT (US); Chandira McNeill, West Haven, CT (US)

(73) Assignee: SIKORSKY AIRCRAFT CORPORATION, Stratford, CT (US)

(21) Appl. No.: 13/095,993

(22) Filed: Apr. 28, 2011

(51) Int. Cl. B32B 7/08; B32B 9/04; B32B 37/14; B32B 3/00; B32B 37/02; B32B 37/06

(52) U.S. Cl. 428/223; 156/60; 156/91; 428/332; 428/411.1

(57) ABSTRACT

A method of sealing between two components includes applying and curing a layer of fay surface sealant to a first component. A layer of liquid shim is applied to one or more of the first component and a second component. The first component is assembled to the second component with the layer of fay surface sealant and the layer of liquid shim therebetween. An assembly of two components includes a first component and a layer of fay surface sealant applied and cured to a first facing surface of the first component. A second component includes a second facing surface, such that the second facing surface and the layer of fay surface sealant define a gap therebetween. A layer of liquid shim is located between the second component and the layer of fay surface sealant thereby substantially filling the gap.

### FEDERAL RESEARCH STATEMENT

This invention was made with Government support under N00019-06-C-0081 awarded by the Department of the Navy. The Government has certain rights in this invention.

### BACKGROUND OF THE INVENTION

The subject matter disclosed herein relates to aircraft structures. More specifically, the subject disclosure relates to fay surface sealant applications between adjoining aircraft components.

Interfaces between adjoining components of aircraft structures often require the application of a fay surface sealant on one or both of the components. The typical fay surface sealant is a flexible sealant that attaches to one or both of the components and acts as a sealing membrane and may be, for example, a urethane, rubber or silicone material. The sealant is applied, especially in cases where the adjoining components are of dissimilar materials such as aluminum and graphite, to prevent corrosion. Some interfaces also require the application of a liquid shim to close up gaps between the components due to typical manufacturing tolerances. Typical materials used as liquid shims include curing methyl methacrylate adhesives, urethanes and epoxies. Application of the liquid shim and fay surface sealant at such interfaces can be a difficult and time-consuming process. They typical process includes applying the liquid shim to one or both of the components and adhering a release tape or the like to the facing surface. The components are then assembled and the liquid shim cures to the desired thickness. Fastener holes for final assembly are drilled out to full size through the cured liquid shim. The components are then disassembled and the release tape is removed and the components and liquid shim are deburred. The fay surface sealant is then applied to one of the components, the components are reassembled, requiring realignment of the installation holes. Finally, fasteners are installed as required to secure the components at the interface with the fay surface sealant and liquid shim therebetween.

### BRIEF DESCRIPTION OF THE INVENTION

According to one aspect of the invention, a method of sealing between two components includes applying and curing a layer of fay surface sealant to a first component. A layer of liquid shim is applied to one or more of the first component and a second component. The first component is assembled to the second component with the layer of fay surface sealant and the layer of liquid shim therebetween.

According to another aspect of the invention, an assembly of two components includes a first component and a layer of fay surface sealant applied and cured to a first facing surface of the first component. A second component includes a second facing surface, such that the second facing surface and the layer of fay surface sealant define a gap therebetween. A layer of liquid shim is located between the second component and the layer of fay surface sealant thereby substantially filling the gap.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

The FIGURE is a schematic cross-sectional view of a joint between two components.

The detailed description explains embodiments of the invention, together with advantages and features, by way of example with reference to the drawings.

### DETAILED DESCRIPTION OF THE INVENTION

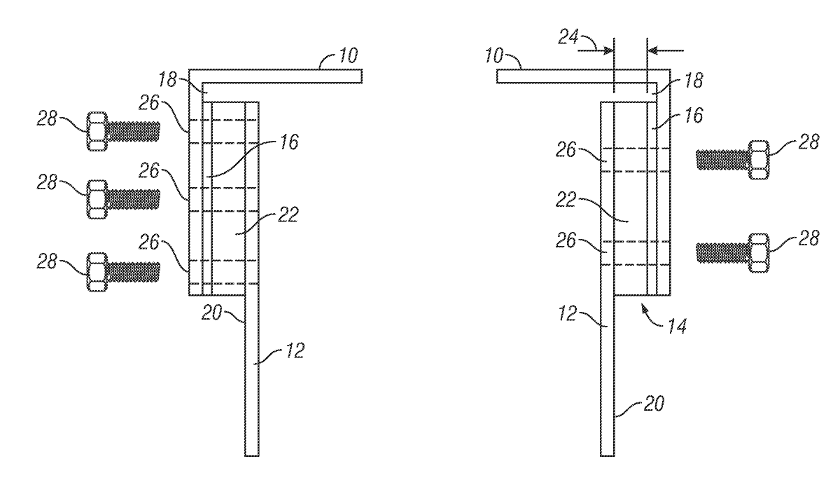

Shown in FIG. 1 is a schematic of an improved method for securing components at an interface including utilization of liquid shim and fay surface sealant. A first component 10 is secured to a second component 12 at an interface 14. In some embodiments, the first component 10 and the second component 12 are aircraft components, for example, fittings, ducts, or external skin components. In some embodiments, the first component 10 and the second component 12 are formed of the same material, or similar materials. In other embodiments, the first component 10 is formed from a material different or dissimilar from the second component 12. For example, the first component 10 may be formed from a metallic material such as an aluminum or aluminum alloy, while the second component 12 may be formed from a non-metallic material such as a graphite or composite material. Such interfaces where the first component 10 and the second component 12 require the use of fay surface sealant to prevent corrosion caused by direct contact between the first component 10 and the second component 12.

In the improved process, a thin coat of fay surface sealant 16 is applied to the first component 10 at a first facing surface 18 that, when assembled to the second component 12 abuts a second facing surface 20 of the second component. In some embodiments, the fay surface sealant is a flexible sealant which is, for example, a urethane, rubber or silicone material. The fay surface sealant 16 may be applied by brush, sprayer, to other suitable means, and in some embodiments is applied to a maximum thickness of 0.010″ (0.254 mm) The fay surface sealant 16 is cured on the first component by, for example, the application of heat or alternatively via a room temperature cure. As such, the fay surface sealant 16 can be applied and cured prior to assembly, even at another location other than the assembly location.

Once the fay surface sealant 16 is cured, a layer of liquid shim 22 material is applied to the first component 10 and/or the second component 12 at the first facing surface 18 and/or the second facing surface 18. In some embodiments, the liquid shim material is a curing methyl methacrylate adhesives, urethane or epoxy. The liquid shim 22 is installed over the fay surface sealant 16. The liquid shim 22 is utilized to eliminate a gap 24 due to, for example, manufacturing tolerances of the first component 10 and/or the second component 12, between the first facing surface 18 and the second facing surface 20 when the first component 10 is assembled to the second component 12. The liquid shim 22 is applied via brush, sprayer or other suitable means.

When the liquid shim 22 is applied, the first component 10 is assembled to the second component 12 at the interface 14. In some embodiments, a liquid shim thickness as applied is greater than the gap 24. In such embodiments, when the first component 10 is assembled to the second component 12, excess liquid shim 22 is squeezed from the gap 24. The first component 10 is then secured to the second component 12 by, for example, drilling a plurality of fastener holes 26 extending through the first component 10 and the second component 12. A plurality of fasteners 28, for example, screws, rivets, bolts, pins, or the like are installed in the fastener holes 26 to secure the first component 10 to the second component 12, with the layer of fay surface sealant 14 therebetween to prevent corrosion of the first component 10 and/or the second components, and a layer of liquid shim 20 to eliminated gaps 22 between the first component 10 and the second component 12 at the interface 14.

The method of the present disclosure allows for installation of liquid shim at the interface without the need to assemble the components after application of the liquid shim, disassemble the components once the liquid shim cures, and then reassemble after application of a layer of fay surface sealant. Further, the present method eliminates the need for the use of release tape or the like to allow for disassembly during the process, and allows for the application of fay surface sealant prior to assembly, even offsite.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of sealing between two components comprising:
applying a layer of fay surface sealant to a first component;
curing the fay surface sealant;
applying a layer of liquid shim to one or more of the first component and a second component; and
assembling the first component to the second component with the layer of fay surface sealant and the layer of liquid shim therebetween.

2. The method of claim 1, further comprising securing the first component to the second component via one or more mechanical fasteners.

3. The method of claim 2, further comprising:
forming one or more fastener installation holes extending through the first component and into the second component; and
installing the one or more mechanical fasteners in the one or more fastener installation holes.

4. The method of claim 1, further comprising squeezing excess liquid shim from between the first component and the second component.

5. The method of claim 1, further comprising applying the layer of fay surface sealant at a maximum thickness of 0.010″.

6. The method of claim 1, further comprising curing the fay surface sealant via an application of heat.

7. An assembly of two components comprising:
a first component;
a layer of fay surface sealant applied and cured to a first facing surface of the first component;
a second component including a second facing surface, such that the second facing surface and the layer of fay surface sealant define a gap therebetween; and
a layer of liquid shim between the second component and the layer of fay surface sealant thereby substantially filling the gap.

8. The assembly of claim 7, further comprising one or more mechanical fasteners securing the first component to the second component.

9. The assembly of claim 8, wherein the one or more mechanical fasteners comprise one or more screws, pins, bolts or rivets.

10. The assembly of claim 7, wherein the layer of fay surface sealant is a maximum of about 0.010″ in thickness.

11. The assembly of claim 7, wherein an applied thickness of liquid shim is greater than the gap.
